(19) United States
(12) Patent Application Publication
(10) Pub. No.: US 2025/0376093 A1
(43) Pub. Date: Dec. 11, 2025

(54) VEHICLE SEAT

(71) Applicant: TACHI-S CO., LTD., Tokyo (JP)

(72) Inventors: Yasuhiro SUZUKI, Tokyo (JP); Mitsuhisa NAKAMURA, Tokyo (JP); Takeshi NISHINA, Tokyo (JP)

(73) Assignee: TACHI-S CO., LTD., Tokyo (JP)

(21) Appl. No.: 19/226,175

(22) Filed: Jun. 3, 2025

(30) Foreign Application Priority Data
Jun. 5, 2024 (JP) 2024-091211

(51) Int. Cl. B60N 2/427; B60N 2/22

(52) U.S. Cl. CPC B60N 2/42709; B60N 2/22

(57) ABSTRACT

A vehicle seat includes a seat cushion including a first side frame, a seat back including a second side frame, and an adjustment mechanism which adjusts an inclination of the seat back with respect to the seat cushion. The adjustment mechanism includes a support member fastened to the first side frame by a first fastening member and a second fastening member, and a pivot shaft pivotably supported by the support member and fixed to the second side frame. The vehicle seat further includes a plate stretched between the first and second fastening members. The support member is movable within a predetermined range with respect to the first side frame. The plate has a specific region configured to deform more easily in a thickness direction than other regions when a force that causes the support member to move within the predetermined range is applied to the support member.

### CROSS-REFERENCE TO RELATED APPLICATIONS

This application is based on and claims priority under 35 USC 119 from Japanese Patent Application No. 2024-091211 filed on Jun. 5, 2024, the entire content of which is incorporated herein by reference.

### TECHNICAL FIELD

The present disclosure relates to a vehicle seat.

### BACKGROUND ART

JP2013-527078A and JP2012-071799A describe a vehicle seat provided with an L-shaped plate for impact absorption.

An object of the present disclosure is to provide a vehicle seat having impact absorption performance.

### SUMMARY OF INVENTION

According to an aspect of the present disclosure, there is provided a vehicle seat including:
a seat cushion including a first side frame;
a seat back including a second side frame; and
an adjustment mechanism configured to adjust an inclination of the seat back with respect to the seat cushion, in which
the adjustment mechanism includes:
   a support member fastened to the first side frame by a first fastening member and a second fastening member; and
   a pivot shaft pivotably supported by the support member and fixed to the second side frame,
the vehicle seat further includes a plate stretched between the first fastening member and the second fastening member,
the support member is configured to be allowed to move within a predetermined range with respect to the first side frame, and
the plate has a specific region configured to deform more easily in a thickness direction than other regions when a force that causes the support member to move within the predetermined range is applied to the support member.

### BRIEF DESCRIPTION OF DRAWINGS

Exemplary embodiment(s) of the present invention will be described in detail based on the following figures, wherein:

FIG. 1 is an external perspective view illustrating a schematic configuration of a vehicle seat 100 according to an embodiment of the technique of the present disclosure;

FIG. 2 is a partially enlarged perspective view schematically illustrating an internal configuration of the vehicle seat 100 illustrated in FIG. 1;

FIG. 3 is a partially enlarged perspective view schematically illustrating the internal configuration of the vehicle seat 100 illustrated in FIG. 1, as viewed from a direction different from that in FIG. 2;

FIG. 4 is a schematic view of a main portion in the vicinity of a rear end portion of a right side frame 11R as viewed from a left side; and

FIG. 5 is a perspective view illustrating the main portion in the vicinity of the rear end portion of the right side frame 11R.

### DESCRIPTION OF EMBODIMENTS

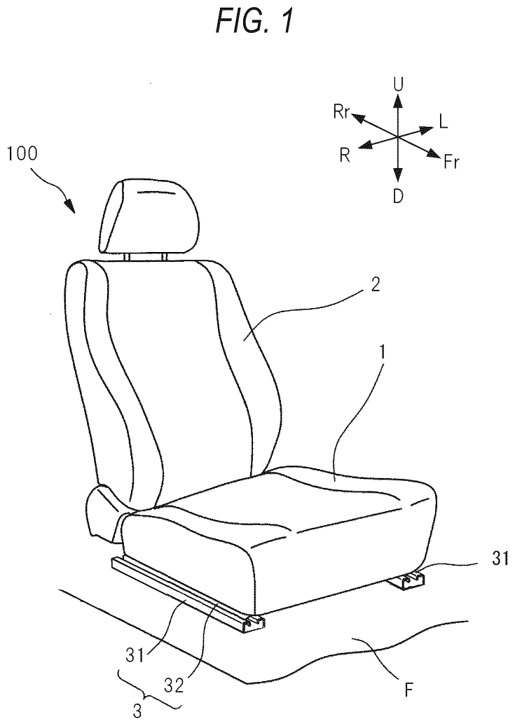

FIG. 1 is an external perspective view illustrating a schematic configuration of a vehicle seat 100 according to an embodiment of the technique of the present disclosure. The vehicle in the present specification includes an automatic vehicle, an aircraft, a train, a moving drone, a ship, and the like. In the following description, a front side of an occupant who sits in a normal posture on the vehicle seat 100 is referred to as a frontward direction Fr, a direction opposite to the frontward direction Fr is referred to as a rearward direction Rr, and the frontward and rearward directions are collectively referred to as a front-rear direction. A right side of the occupant when the occupant is viewed from a rear side is referred to as a rightward direction R, a left side of the occupant is referred to as a leftward direction L, and the leftward and rightward directions are collectively referred to as a left-right direction. A direction perpendicular to the front-rear direction and the left-right direction and extending from a head rest toward a seating surface is referred to as a downward direction D, a direction opposite to the downward direction D is referred to as an upward direction U, and the upward and downward directions are collectively referred to as an up-down direction. The front-rear direction, the left-right direction, and the up-down direction intersect with each other. The vehicle seat 100 includes a seat cushion 1 that supports buttocks and thighs of the occupant, and a seat back 2 that supports a waist and a back of the occupant. In the example of FIG. 1, the vehicle seat 100 is a driver's seat or a passenger's seat of an automatic vehicle.

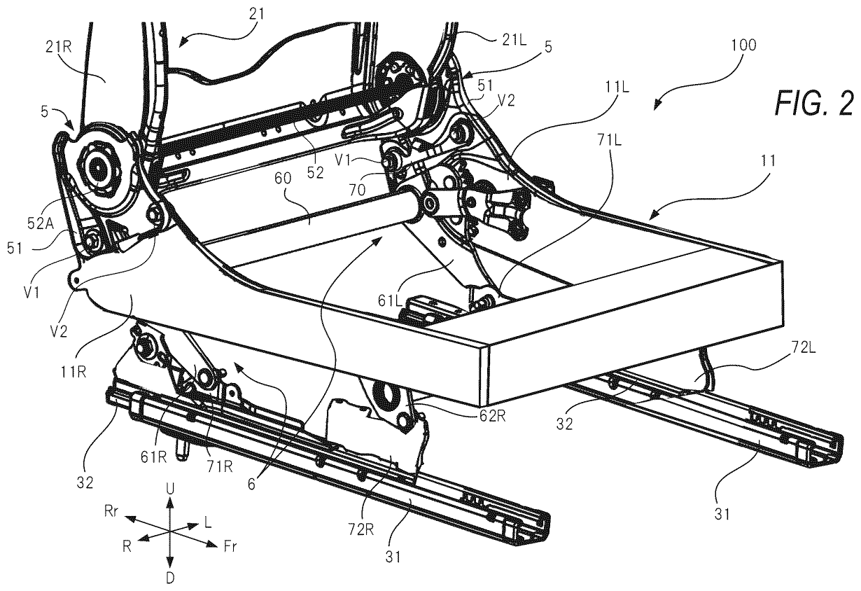

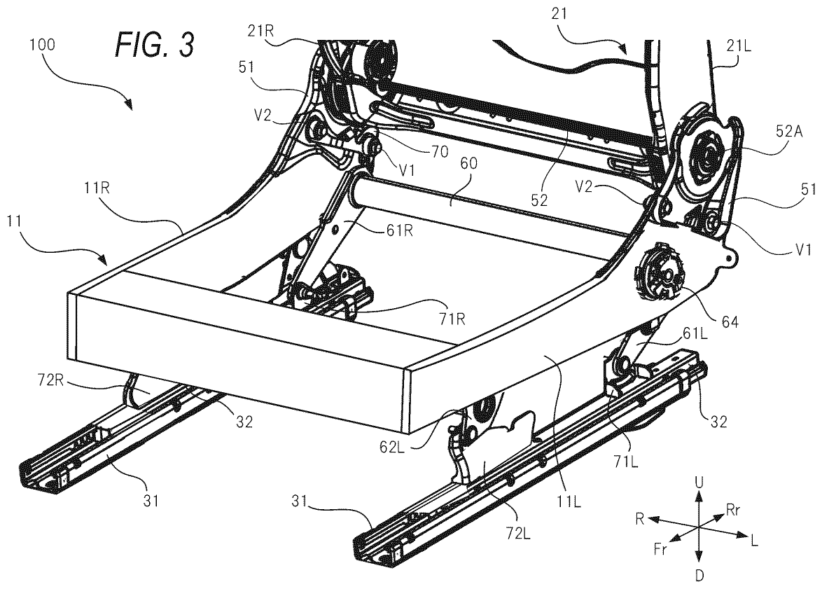

The seat cushion 1 includes a cushion frame 11 (see FIGS. 2 and 3) that forms a framework. The cushion frame 11 is covered with a pad (not illustrated) made of a relatively soft resin foam material such as urethane foam, and is further covered with a trim cover (not illustrated) including a skin material such as leather, woven fabric, or nonwoven fabric.

The seat back 2 includes a back frame 21 (see FIGS. 2 and 3) that forms a framework (not illustrated). The back frame 21 is covered with a pad (not illustrated) made of a relatively soft resin foam material such as urethane foam, and is further covered with a trim cover (not illustrated) including a skin material such as leather, woven fabric, or nonwoven fabric.

The vehicle seat 100 includes a pair of rail mechanisms 3 fixed to a vehicle body floor F and located directly below the seat cushion 1, and a foot bracket (not illustrated) disposed between the rail mechanisms 3 and the vehicle body floor F and supporting the seat cushion 1 from below via the rail mechanisms 3.

The rail mechanism 3 is located directly below the seat cushion 1 to support the seat cushion 1, and can cause the seat cushion 1 to move along the front-rear direction. The rail mechanism 3 includes two long rails extending in the front-rear direction, specifically, a lower rail 31 as a fixed rail and an upper rail 32 as a movable rail. The upper rail 32 can slide along a longitudinal direction (that is, the front-rear direction) of the lower rail 31 together with the seat cushion 1 supported on an upper surface thereof.

FIG. 2 is a partially enlarged perspective view schematically illustrating an internal configuration of the vehicle seat 100 illustrated in FIG. 1. FIG. 2 illustrates a state where a pad and a trim cover of the seat cushion 1 and a pad and a trim cover of the seat back 2 are removed. FIG. 3 is a partially enlarged perspective view schematically illustrating the internal configuration of the vehicle seat 100 illustrated in FIG. 1, as viewed from a direction different from that in FIG. 2.

The cushion frame 11 of the seat cushion 1 includes a left side frame 11L and a right side frame 11R arranged side by side in the left-right direction and extending in the front-rear direction. In the example of FIGS. 2 and 3, the left side frame 11L and the right side frame 11R are each formed in a plate shape having a thickness in the left-right direction.

The back frame 21 of the seat back 2 includes a left side frame 21L and a right side frame 21R arranged side by side in the left-right direction and extending in the up-down direction. In the example of FIGS. 2 and 3, the left side frame 21L and the right side frame 21R are each formed in a plate shape having a thickness in the left-right direction.

The vehicle seat 100 includes a reclining device 5 that adjusts the inclination of the seat back 2 with respect to the seat cushion 1, and a seat lifter device 6 that adjusts a height of the seat cushion 1 in the up-down direction. The seat lifter device 6 includes a parallel link mechanism, and includes a left rear link member 61L provided at the rear left, a right rear link member 61R provided at the rear right, a left front link member 62L provided at the front left, a right front link member 62R provided at the front right, and a cylindrical torque rod 60 made of a pipe material or the like, which rotatably passes through through holes that penetrate to the left and right and are formed in a rear end portion of the left side frame 11L and a rear end portion of the right side frame 11R, respectively.

The left rear link member 61L has a lower end side pivotably coupled to a riser 71L via a hinge pin or the like, and an upper end side coupled to a left end portion of the torque rod 60. As illustrated in FIG. 3, a manual operation portion 64 for manually operating the seat lifter device 6 is fixed to a left side surface of the left side frame 11L. The manual operation portion 64 can be changed to a motor that is operated by operating an operation button or the like (not illustrated). A power of the manual operation portion 64 or the motor can be transmitted to the left rear link member 61L.

The right rear link member 61R has a lower end side pivotably coupled to a riser 71R via a hinge pin or the like, and an upper end side coupled to a right end portion of the torque rod 60.

The left front link member 62L has a lower end side pivotably coupled to a riser 72L via a hinge pin or the like, and an upper end side pivotably coupled to a front end portion of the left side frame 11L.

The right front link member 62R has a lower end side pivotably coupled to a riser 72R via a hinge pin or the like, and an upper end side pivotably coupled to a front end portion of the right side frame 11R.

The reclining device 5 includes a pair of left and right base plates 51 fastened to respective rear end portions of the left side frame 11L and the right side frame 11R by a first fastening member V1 implemented by a bolt, a nut, and the like, and a second fastening member V2 implemented by a bolt, a nut, and the like, and a pivot shaft 52 pivotably supported by the base plate 51 and fixed to the back frame 21.

The base plate 51 is formed in a plate shape having a thickness in the left-right direction. The pivot shaft 52 extends in the left-right direction, and both ends 52A thereof are pivotably supported by the pair of base plates 51.

The left and right base plates 51 are allowed to move within a predetermined range with respect to the left side frame 11L and the right side frame 11R, respectively. When an impact is applied from behind to the vehicle on which the vehicle seat 100 is mounted, a downward force is applied to the back frame 21 and the base plate 51 connected to the back frame 21 via the pivot shaft 52. The base plate 51 is movable slightly downward when such a force is applied. By moving the base plate 51, the seat back 2 is moved downward, and the impact can be reduced.

The nuts of the first fastening member V1 and the second fastening member V2 may be either square nuts or round nuts, and are preferably round nuts.

The vehicle seat 100 further includes impact absorbing plates 70 each stretched between the first fastening member V1 and the second fastening member V2 in each of the pair of base plates 51.

The impact absorbing plate 70 is formed in a plate shape having a thickness in the left-right direction. The impact absorbing plate 70 preferably has a uniform thickness. The left impact absorbing plate 70 is fastened to an inner surface of the rear end portion of the left side frame 11L by the first fastening member V1 and the second fastening member V2. The right impact absorbing plate 70 is fastened to an inner surface of the rear end portion of the right side frame 11R by the first fastening member V1 and the second fastening member V2.

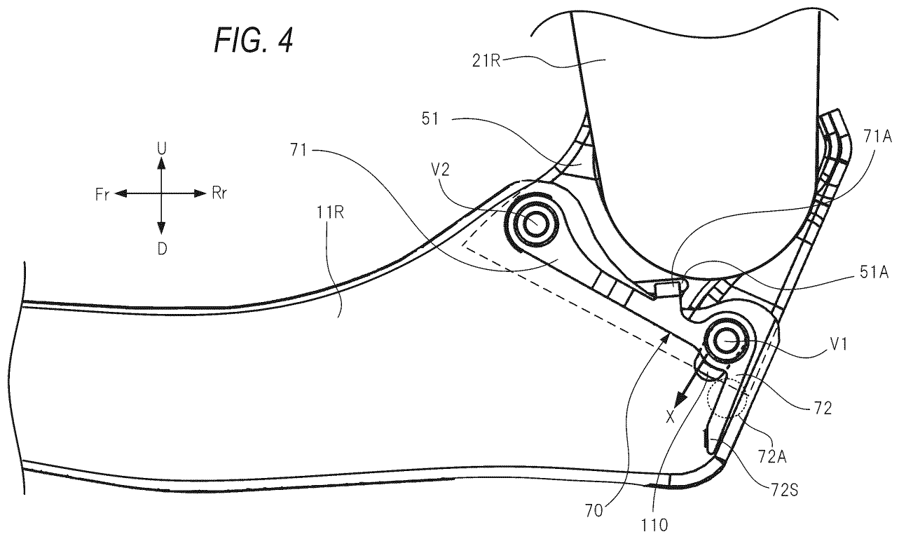

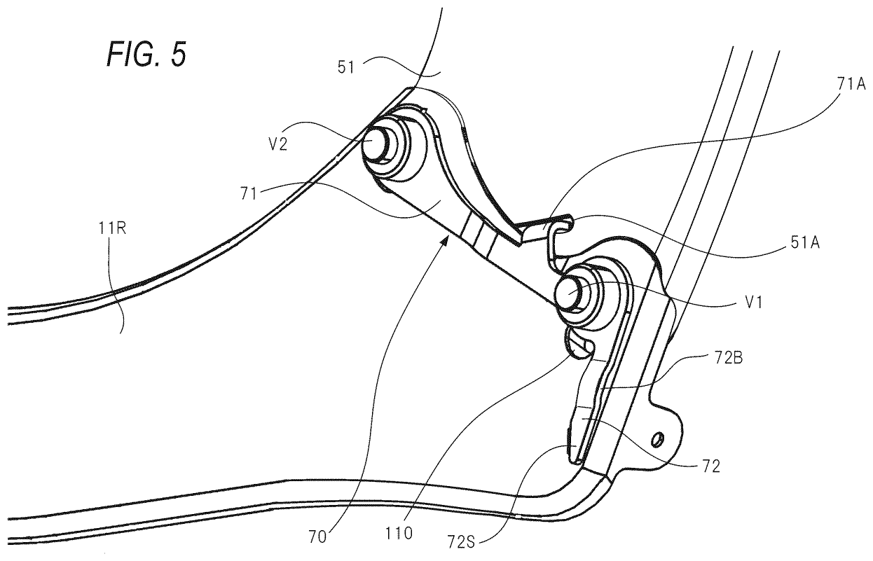

FIG. 4 is a schematic view of a main portion in the vicinity of the rear end portion of the right side frame 11R as viewed from a left side. FIG. 5 is a perspective view illustrating the main portion in the vicinity of the rear end portion of the right side frame 11R. The configurations of the left side frame 11L, and the base plate 51 and impact absorbing plate 70 fastened to the left side frame 11L are similar to the configurations of the right side frame 11R, and the base plate 51 and impact absorbing plate 70 fastened to the right side frame 11R, and thus the description thereof will be omitted.

As illustrated in FIGS. 4 and 5, the impact absorbing plate 70 includes a base portion 71 extending from a fastening location by the first fastening member V1 to a fastening location by the second fastening member V2, and an extension portion 72 extending from an end portion of the base portion 71 on a side of the first fastening member V1.

The extension portion 72 extends in a direction intersecting an extending direction of the base portion 71 (synonymous with a direction in which the first fastening member V1 and the second fastening member V2 are arranged).

The right side frame 11R is provided with through holes for passing bolts of the first fastening member V1 and the second fastening member V2. The through hole through which the bolt of the second fastening member V2 is inserted is circular and has an inner diameter small enough that the bolt cannot move radially inside. On the other hand, the through hole 110 through which the bolt of the first fastening member V1 is inserted is a long hole, and when a strong downward force is applied to the base plate 51, the bolt is movable inside in the longitudinal direction X. In this way, the base plate 51 is fastened to the right side frame 11R so that when a large force is applied in the downward direction D, the fastening location of the first fastening member V1 can move along the longitudinal direction X of the through hole 110, with the fastening location of the second fastening member V2 as a fulcrum.

In the example of FIG. 4, the through hole 110 extends in a direction intersecting the extending direction of the base portion 71 at an angle of approximately 90 degrees. The through hole 110 has a region that extends in the downward direction D and the frontward direction Fr from a region through which the bolt of the first fastening member V1 is inserted. The extension portion 72 of the impact absorbing plate 70 extends along the longitudinal direction X of the through hole 110, that is, a direction in which the base plate 51 is movable. In the example of FIG. 4, the extension portion 72 extends downward and in the direction intersecting the extending direction of the base portion 71 at an angle of approximately 90 degrees. A distal end portion 72S of the extension portion 72 is fixed to an inner surface of the right side frame 11R by welding, adhesion, or the like. The impact absorbing plate 70 is provided with a specific region 72A configured to deform more easily in a thickness direction than other regions when a force that causes the base plate 51 to move is applied to the base plate 51.

As illustrated in FIG. 5, the extension portion 72 has a substantially uniform thickness. The specific region 72A includes a bulging portion 72B that is provided between a base end portion and the distal end portion 72S of the extension portion 72 and bulges in the thickness direction of the extension portion 72. The bulging portion 72B bulges in a direction (leftward direction L) away from the right side frame 11R. The bulging portion 72B is provided between the fastening location of the first fastening member V1 and the distal end portion 72S fixed to the right side frame 11R. Therefore, when the first fastening member V1 tries to move in the longitudinal direction X in FIG. 4, a compressive force acts on the extension portion 72 in the longitudinal direction X. When the extension portion 72 is compressed, the specific region 72A provided with the bulging portion 72B is likely to be bent in the bulging direction. In this way, when the force that causes the base plate 51 to move is applied to the base plate 51, the specific region 72A of the impact absorbing plate 70 can be deformed preferentially over the other regions.

When a force is applied to the base plate 51, the first fastening member V1 moves within the through hole 110 while buckling the specific region 72A in the direction away from the right side frame 11R. According to the vehicle seat 100, the force applied to the base plate 51 is absorbed by the buckling of the specific region 72A, and thus the movement of the base plate 51 can be made gentle.

As illustrated in FIG. 4, the bulging portion 72B is provided across the entire width of the extension portion 72, but by adjusting a bulging height and a bulging width of the bulging portion 72B and a dimension of a bending R, a timing of deformation in the bulging direction against the force in the longitudinal direction X can be adjusted.

As illustrated in FIGS. 4 and 5, the base plate 51 is provided with a hole 51A penetrating in the left-right direction. The impact absorbing plate 70 is provided with an insertion piece 71A that extends from a portion of the base portion 71 between the first fastening member V1 and the second fastening member V2 and is inserted into the hole 51A. The hole 51A and the insertion piece 71A are configured such that an inner surface of the hole 51A can abut against the insertion piece 71A while the first fastening member V1 moves in the longitudinal direction X. According to this configuration, when the first fastening member V1 moves in the longitudinal direction X, the base plate 51 can be gently moved by the engagement between the hole 51A and the insertion piece 71A.

As described above, the following matters are disclosed in the present specification. In the following parentheses, corresponding components and the like in the above embodiment are described, but the present invention is not limited thereto.

(1) A vehicle seat (vehicle seat 100) including:
a seat cushion (seat cushion 1) including a first side frame (right side frame 11R and left side frame 11L);
a seat back (seat back 2) including a second side frame (right side frame 21R and left side frame 21L); and
an adjustment mechanism (reclining device 5) configured to adjust an inclination of the seat back with respect to the seat cushion, in which
the adjustment mechanism includes:
   a support member (base plate 51) fastened to the first side frame by a first fastening member (first fastening member V1) and a second fastening member (second fastening member V2); and
   a pivot shaft (pivot shaft 52) pivotably supported by the support member and fixed to the second side frame,
the vehicle seat further includes a plate (impact absorbing plate 70) stretched between the first fastening member and the second fastening member,
the support member is configured to be allowed to move within a predetermined range with respect to the first side frame, and
the plate has a specific region (specific region 72A) configured to deform more easily in a thickness direction than other regions when a force that causes the support member to move within the predetermined range is applied to the support member.

According to (1), when a force that causes the support member to move is applied to the support member due to an impact applied from behind to a vehicle on which the vehicle seat is mounted, the specific region of the plate can be deformed preferentially in the thickness direction. In this way, for example, a direction in which the plate deforms can be made different from a direction in which the plate moves in association with the movement of the support member and the fastening member. According to this configuration, the force applied to the support member is effectively dispersed, and the support member, and the adjustment mechanism and the seat back connected to the support member are moved gently, thereby making it possible to absorb the impact.

(2) The vehicle seat according to (1), in which
the plate has an extension portion (extension portion 72) extending from an end portion on a side of one (first fastening member V1) of the first fastening member and the second fastening member,
a distal end portion (distal end portion 72S) of the extension portion is fixed to the first side frame, and
the specific region is provided in the extension portion.

According to (2), for example, when a force acts to cause the support member to move with a fastening location of an other one of the first fastening member and the second fastening member as a fulcrum, by providing the extension portion along a movement direction thereof, the fastening location of one of the first fastening member and the second fastening member can be moved gently while deforming the specific region provided in the extension portion in the thickness direction thereof. As a result, the support member, and the adjustment mechanism and the seat back connected to the support member are moved gently, thereby making it possible to absorb the impact.

(3) The vehicle seat according to (2), in which
the support member is configured to be movable within the predetermined range, with a fastening location (location fastened by the second fastening member V2) of an other one of the first fastening member and the second fastening member as a fulcrum, and the extension portion extends along a direction (longitudinal direction X) in which the support member is movable.

According to (3), when the force acts to cause the support member to move with the fastening location of the other one of the first fastening member and the second fastening member as a fulcrum, the fastening location of one of the first fastening member and the second fastening member can be moved gently while deforming the specific region provided in the extension portion in the thickness direction thereof.

(4) The vehicle seat according to (2) or (3), in which
the specific region is configured to include a bulging portion (bulging portion 72B) that bulges in a thickness direction of the extension portion.

According to (4), the specific region can be easily deformed in the direction in which the bulging portion bulges.

(5) The vehicle seat according to any one of (2) to (4), in which
the plate has an insertion piece (insertion piece 71A) provided between the first fastening member and the second fastening member, the insertion piece being inserted into a hole (hole 51A) formed in the support member.

According to (5), the movement of the support member can be made more gently by the engagement between the insertion piece and the hole.

(6) The vehicle seat according to any one of (2) to (5), in which
one of the first fastening member and the second fastening member is configured to include a round nut.

According to (6), a distance between a fastening point of one of the first fastening member and the second fastening member and a fixing point of the extension portion to the first side frame can be made constant. Therefore, the specific region can be deformed in an intended manner regardless of a fastening state of the fastening member.

What is claimed is:

1. A vehicle seat comprising:
a seat cushion including a first side frame;
a seat back including a second side frame; and
an adjustment mechanism configured to adjust an inclination of the seat back with respect to the seat cushion, wherein
the adjustment mechanism includes:
a support member fastened to the first side frame by a first fastening member and a second fastening member; and
a pivot shaft pivotably supported by the support member and fixed to the second side frame,
the vehicle seat further comprises a plate stretched between the first fastening member and the second fastening member,
the support member is configured to be allowed to move within a predetermined range with respect to the first side frame, and
the plate has a specific region configured to deform more easily in a thickness direction than other regions when a force that causes the support member to move within the predetermined range is applied to the support member.

2. The vehicle seat according to claim 1, wherein
the plate has an extension portion extending from an end portion on a side of one of the first fastening member and the second fastening member,
a distal end portion of the extension portion is fixed to the first side frame, and
the specific region is provided in the extension portion.

3. The vehicle seat according to claim 2, wherein
the support member is configured to be movable within the predetermined range, with a fastening location of an other one of the first fastening member and the second fastening member as a fulcrum, and
the extension portion extends along a direction in which the support member is movable.

4. The vehicle seat according to claim 2, wherein
the specific region is configured to include a bulging portion that bulges in a thickness direction of the extension portion.

5. The vehicle seat according to claim 4, wherein
the plate has an insertion piece provided between the first fastening member and the second fastening member, the insertion piece being inserted into a hole formed in the support member.

6. The vehicle seat according to claim 5, wherein
one of the first fastening member and the second fastening member is configured to include a round nut.
